(19) United States
(12) Patent Application Publication
(10) Pub. No.: US 2009/0136317 A1
(43) Pub. Date: May 28, 2009

(54) Anti-loosening set screw for carburetor

(75) Inventor: XIANXIANG CHEN, Guangdong Province (CN)

Correspondence Address: YH Chan, 42 Pin Oaks Drive, Phoenixville, PA, 19460, US

(73) Assignee: FUJIAN HUALONG CARBURETOR CO., LTD., Fuding City (CN)

(21) Appl. No.: 12/248,879

(22) Filed: Oct. 9, 2008

(30) Foreign Application Priority Data
Nov. 23, 2007 (CN) 200720059943.7

(51) Int. Cl. F16B 39/04

(52) U.S. Cl. 411/295

(57) ABSTRACT

The present invention relates to an anti-loosening set screw for a carburetor, comprising a cylindrical body, a front end of the body is disposed with an adjusting section, a rear end of the body is disposed with a head with a slot, the body has a cylindrical face which is disposed with an exterior screw thread section, wherein the cylindrical face of the body is further disposed with a recessed ring groove, the ring groove is disposed with a ring-shaped elastic plastic body which is integrally formed therewith by injection molding. In comparison with the prior art, the present invention has the advantages of simple construction, close cooperation, good anti-loosening and tight sealing effects and so forth.

### BACKGROUND OF THE INVENTION

The present invention relates to a set screw for a carburetor and more particularly pertains to an anti-loosening set screw for a carburetor.

A carburetor is disposed with a high-speed set screw and a low-speed set screw. In general, the high-speed fuel supply rate and the low-speed fuel supply rate of a carburetor are controlled by a high-speed set screw and a low-speed set screw respectively. Taking a high-speed set screw as an example: when the high-speed set screw is screwed into the body of a carburetor, the high-speed flow rate of the carburetor is set by means of calibrating the number of laps that the high-speed set screw is opted in the body of the carburetor, because the flow rate is the fuel inflow rate of the carburetor and is controlled by means of a ring-shaped gap coordinated between the tapered degree of the pointed tip of the high-speed set screw and a high-speed fuel inlet. Only when the number of laps of the high-speed set screw is altered, the ring-shaped area between the pointed tip of the high-speed set screw and the high-speed fuel inlet can be changed, thereby changing the fuel inflow rate of the carburetor. When an engine is operated, the vibration thus generated will be transmitted to the high-speed set screw and the low-speed set screw of the carburetor. If the two screws do not have adequate rotation-resistant functions, the number of laps into which the screws are screwed will be changed, the flow rate of the carburetor will be altered, thereby causing the performance of the engine to deteriorate. At present, set screws commonly used on carburetors have spring anti-loosening mechanisms. Being affected by the locking extent of the set screws, anti-loosening springs are occasionally overlapped, and sometimes the preloading extent on the springs may be very little, the tension force of the springs are so little that renders the anti-loosening effect ineffective. Further, the springs cannot attain a tight sealing effect. There are also holders made of elastic plastic bodies, which are first pressed into the bodies of carburetors, set screws are then locked thereto, having the set screws self-tapping screw threads on the elastic plastic bodies. For the holders are made of the elastic plastic bodies, due to the screw threads of the set screws are of machine-cutting in manufacturing process, the saw shape of the screw threads is comparatively sharp, resulting in the partial removal of part of the elastic plastic bodies in the process of locking the set screws into the holders, so when the screws are locked, the friction of the screw threads between the exterior screw threads and the interior screw threads is reduced, thereby the anti-loosening effect is not satisfactory. Whereas, the manufacturing cost of squeezing the exterior screw threads of set screws into shape is susceptibly higher.

### BRIEF SUMMARY OF THE INVENTION

An object of the present invention is to provide an anti-loosening set screw for a carburetor, which is of simple construction, close cooperation, and good anti-loosening and sealing effects.

The present invention adopts the following technical proposal:

An anti-loosening set screw for a carburetor, comprising a cylindrical body, a front end of the body is disposed with an adjusting section, a rear end of the body is disposed with a head with a slot, the body has a cylindrical face which is disposed with an exterior screw thread section, wherein the cylindrical face of the body is further disposed with a recessed ring groove, the ring groove is disposed with a ring-shaped elastic plastic body which is integrally formed therewith by injection molding.

The said anti-loosening set screw for a carburetor, wherein the ring groove of the body is disposed with a small radial through hole therein, inside the hole is disposed with an elastic plastic reinforcement which is integrally formed with the ring-shaped elastic plastic body by injection molding.

The said anti-loosening set screw for a carburetor, wherein the ring-shaped elastic plastic body has an outer wall face which is not higher than an outer edge of the screw thread section.

The said anti-loosening set screw for a carburetor, wherein the ring-shaped elastic plastic body is disposed between the screw thread section and the head.

As the present invention adopts the aforementioned construction, by means of providing a recessed ring groove section in the cylindrical face of the body and the ring-shaped elastic plastic body which is integrally formed with the ring groove by injection molding, when the set screw is locked into a screw thread bore which is squeezed into shape in the body of a carburetor, the ring-shaped elastic plastic body also enters into an interior screw thread. Due to the elasticity of the elastic plastic body, a screw thread is tapped on the ring-shaped elastic plastic body, which is equivalent to forming a self-tapping exterior screw thread. The self-tapping exterior screw thread and the interior screw thread are closely cooperated, and of great elasticity, thereby attaining an excellent anti-loosening and a definitive tight sealing effect.

The present invention is applied to the anti-loosening of set screws by means of a relatively simple method. Besides, due to the close cooperation between the elastic ring-shaped body and the interior screw thread of the body of a carburetor, the present invention can also prevent the air from penetrating into the interior of a carburetor through the screw thread section of the set screws, thereby avoiding the unsteady rotational speed caused by the air mixed into a carburetor and the problems of performance deterioration.

In comparison with the prior art, the present invention has the advantages of simple construction, close cooperation, and good anti-loosening and tight sealing effects and so forth.

### BRIEF DESCRIPTION OF THE DRAWINGS

The present invention is further described with the following accompanying drawings.

FIG. 1 is a view showing the structure of one of the embodiments of the present invention.

FIG. 2 is a right view of FIG. 1.

FIG. 3 is a view showing the structure of another embodiment of the present invention.

FIG. 4 is cross-sectional view taken along the line A-A in FIG. 3.

FIG. 5 is a reference diagram of the present invention in the operating state.

In the drawings: 1 is a body, 11 is an adjusting section, 12 is a head, 12a is a slot, 13 is an exterior screw thread section, 14 is a ring groove, 15 is a ring-shaped elastic plastic body, 16 is a small hole, 17 is an elastic plastic reinforcement.

### DETAILED DESCRIPTION OF THE INVENTION

The present invention is further described in detail with the following accompanying drawings. However, it does not constitute any limitations thereon.

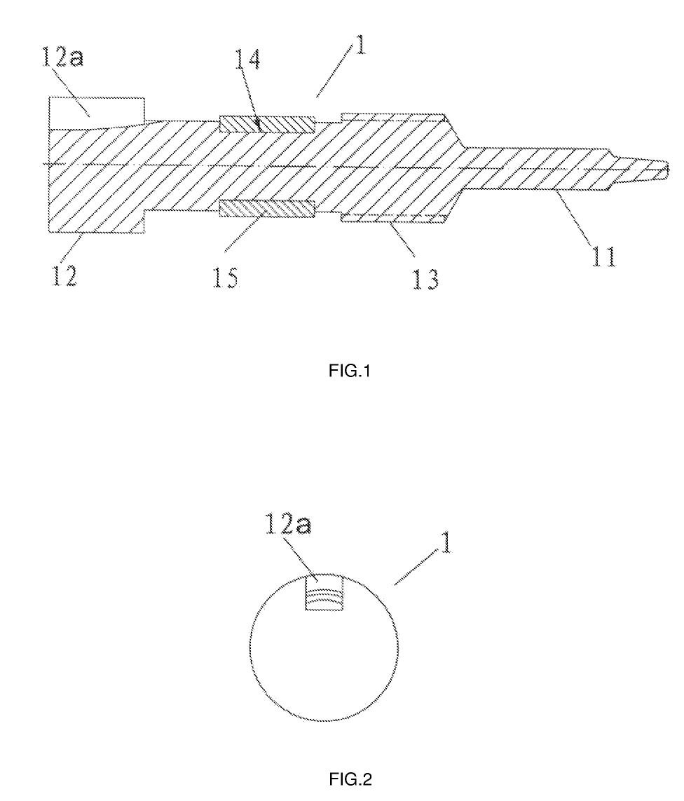

As illustrated in FIGS. 1 and 2, an anti-loosening set screw for a carburetor comprises a cylindrical body 1, a front end of the body 1 is disposed with an adjusting section 11, a rear end of the body 1 is disposed with a head 12 with a slot 12a, the body 1 has a cylindrical face which is disposed with an exterior screw thread section 13, the cylindrical face of the body 1 between the screw thread section 13 and the head 12 is further disposed with a recessed ring groove 14, the ring groove 14 is disposed with a ring-shaped elastic plastic body 15 which is integrally formed therewith by injection molding, the ring-shaped elastic plastic body 15 has an outer wall face which is not higher than an outer edge of the screw thread section 13; the ring-shaped elastic plastic body 15 is of polyoxymethylene (POM).

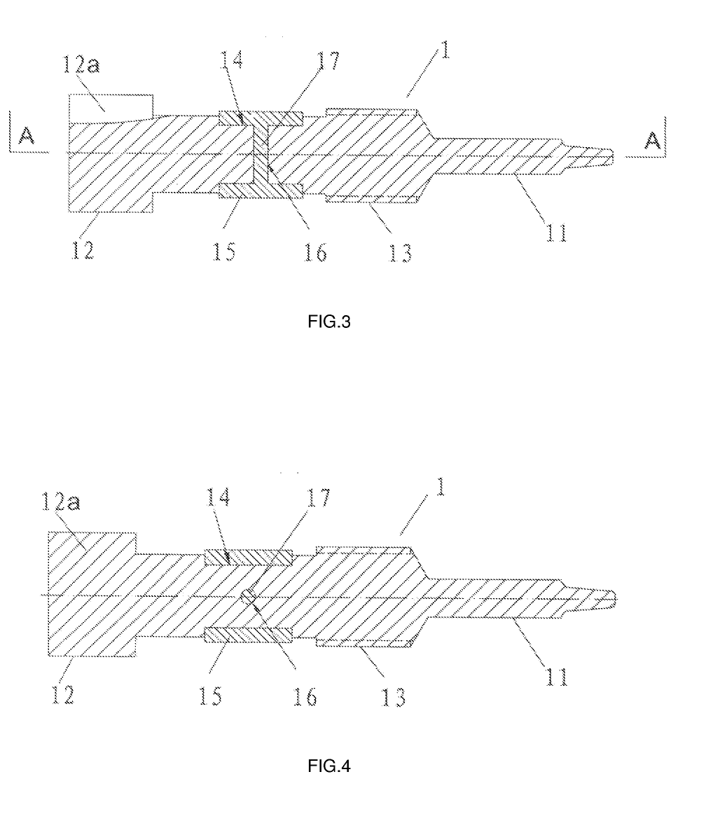

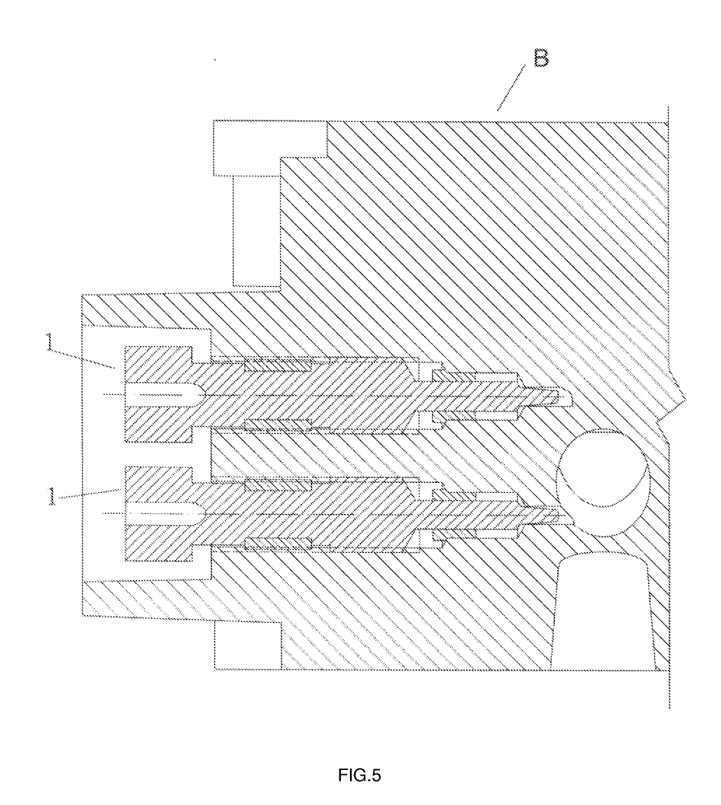

As illustrated in FIGS. 3 and 4, an anti-loosening set screw for a carburetor comprises a cylindrical body 1, a front end of the body 1 is disposed with an adjusting section 11, a rear end of the body 1 is disposed with a head 12 with a slot 12a, the body 1 has a cylindrical face is disposed with an exterior screw thread section 13, the cylindrical face of the body 1 between the screw thread section 13 and the head 12 is further disposed with a recessed ring groove 14, the ring groove 14 is disposed with a ring-shaped elastic plastic body 15 which is integrally formed therewith by injection molding, the ring-shaped elastic plastic body 15 has an outer wall face which is not higher than an outer edge of the screw thread section 13; the ring groove 14 of the body 1 is disposed with a small radial through hole 16 therein; inside the small hole 16 is disposed with an elastic plastic reinforcement 17 which is integrally formed with the ring-shaped elastic plastic body 15 by injection molding, the ring-shaped elastic plastic body 15 and the elastic plastic reinforcement 17 are of polyoxymehtylene (POM).

As illustrated in FIG. 5, when the present invention is in use, the exterior screw thread section 13 of the front end of the body 1 is screwed into a screw thread bore which is squeezed into shape in a carburetor, the exterior screw thread section 13 also drives the ring-shaped elastic plastic body 15 into an interior screw thread. Due to the elasticity of the ring-shaped elastic plastic body 15, a screw thread is tapped on the ring-shaped elastic plastic body 15, which is equivalent to forming a self-tapping exterior screw thread. The self-tapping exterior screw thread and the interior screw thread are closely cooperated, and of great elasticity, thereby attaining an excellent anti-loosening and a definitive tight sealing effect.

What is claimed is:

1. An anti-loosening set screw for a carburetor, comprising a cylindrical body (1), a front end of the body (1) is disposed with an adjusting section (11), a rear end of the body (1) is disposed with a head (12) with a slot (12a), the body has a cylindrical face which is disposed with an exterior screw thread section (13), wherein the cylindrical face of the body (1) is further disposed with a recessed ring groove (14), the ring groove (14) is disposed with a ring-shaped elastic plastic body (15) which is integrally formed therewith by injection molding.

2. An anti-loosening set screw for a carburetor as in claim 1, wherein the ring groove (14) of the body is disposed with a small radial through hole (16) therein, inside the hole (16) is disposed with an elastic plastic reinforcement (17) which is integrally formed with the ring-shaped elastic plastic body (15) by injection molding.

3. An anti-loosening set screw for a carburetor as in claim 1, wherein the ring-shaped elastic plastic body (15) has an outer wall face which is not higher than an outer edge of the screw thread section (13).

4. An anti-loosening set screw for a carburetor as in claim 1, wherein the ring-shaped elastic plastic body (15) is disposed between the screw thread section (13) and the head (12).
